(19) United States
(12) Patent Application Publication
(10) Pub. No.: US 2008/0237290 A1
(43) Pub. Date: Oct. 2, 2008

(54) Manually Controlled, Gas-Operated Tool Having a Real-Time Clock

(75) Inventors: Pierrick Calvet, Saint Nazaire les Eymes (FR); Florent La Bella, Romans Sur Isere (FR); Pascale Grandjean, Valence (FR); Nicolas Guihard, Caluire et Cuire (FR)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: Societe DE Prospection ET D'Inventions Techniques Spit, Bourg-Les-Valence (FR)

(21) Appl. No.: 12/089,740

(22) PCT Filed: Oct. 12, 2006
(86) PCT No.: PCT/IB2006/002852

§ 371 Date: May 13, 2008

(30) Foreign Application Priority Data
Oct. 14, 2005 (FR) 05 10 477

(51) Int. Cl. B25C 1/08

(52) U.S. Cl. 227/2; 227/10; 227/8

(57) ABSTRACT

The tool includes a cylinder inside of which is slidably mounted a piston for driving a fastening element, as a result of the explosion inside of a combustion chamber of a mixture of gas and air that has been injected therein from a gas cartridge, after which the tool has come to bear weight against a support, the head switch has retracted and the combustion chamber has closed, followed by actuation of the trigger switch for controlling the spark plug. The tool also includes an element for determining the rate of fire which includes a real-time clock designed to cooperate with a microcontroller of an operating and control module. The arrangement applies well to fastening tools.

This invention relates to a manually controlled and gas-operated tool, of the fastening tool type, such as a nailing gun or stapler.

The tool comprises a cylinder inside of which is a slidably mounted piston for driving a fastening element, such as a nail or staple, as a function of the explosion inside of a combustion chamber of a mixture of gas and air that has been injected therein from a gas cartridge, after setting the tool into abutment for safety reasons, retractation of the fastener guide and closing of the combustion chamber followed by actuation of the trigger mechanism for controlling the spark plug.

Other than a device for transmitting the gas from the cartridge into the chamber, generally a solenoid valve, the tool further comprises a housing for receiving a battery, a fan for mixing the air and gas of the combustion chamber, a driving motor for the fan, possibly a temperature control module, and an operating and control module for the tool.

The operating and control module carries out its functions which are, in particular, the air-gas mixture, gas control, ignition, firing control, cooling, control of the electrical supply, safety management and failure detection.

In short, a gas-operating tool such as this requires a particular level of attention, all the more so as the service life of the tool may be marked by numerous events, and breakdowns may be multiple and varied.

The applicant has sought to make life easier for the operators and by burning in these gas-operated tools as best as possible.

Therefore, the invention relates to a tool of the type described above, characterised by the fact that it comprises means for determining the rate of fire, which can trigger the means for locking the tool, in the case where the rate is too high and harmful to proper functioning of the tool.

The locking means may include:
means for locking ignition,
means for locking the injection of gas into the chamber,
means for locking control switches for injection and ignition (head switch—fastener guide and trigger switch—trigger mechanism).

Preferably, the means for determining the rate of fire include a real-time clock designed to cooperate with a microcontroller for the operating and control module.

The clock provides a means to date the various firings, establish a chronology and determine the interval of time between firings.

In a general sense, the integration of the real-time clock makes it possible to date the various events in the service life of the tool and the firings, but also to date the moments when the various breakdowns occur. This may enable exact knowledge of the conditions of use of the tool, if it is used regularly for a few firings, or occasionally, for numerous firings. This also serves in the detection of intermittent breakdowns.

Advantageously, a backing storage is provided for the tool's operational data, which cooperates with the microcontroller and the clock in order to control the locking means.

The invention will be better understood with the help of the following description, in reference to the appended figure in which:

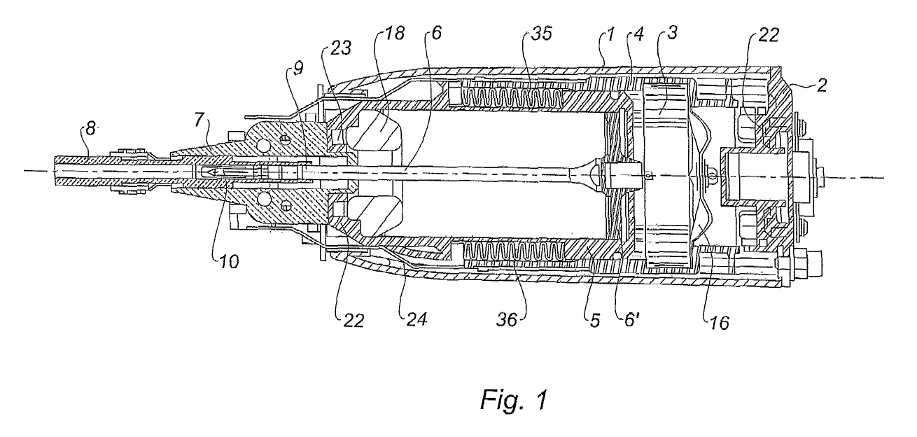

FIG. 1 is an axial cross-section of the preferred embodiment of the invention;

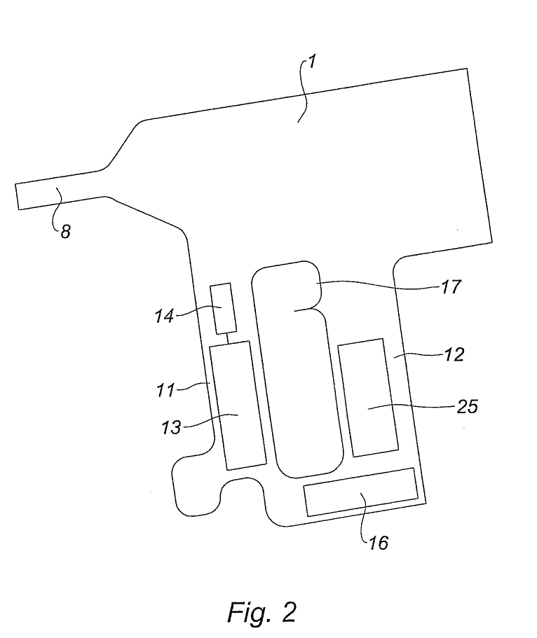

FIG. 2 is a schematic profile view of the tool of FIG. 1, with half of the housing shell removed and,

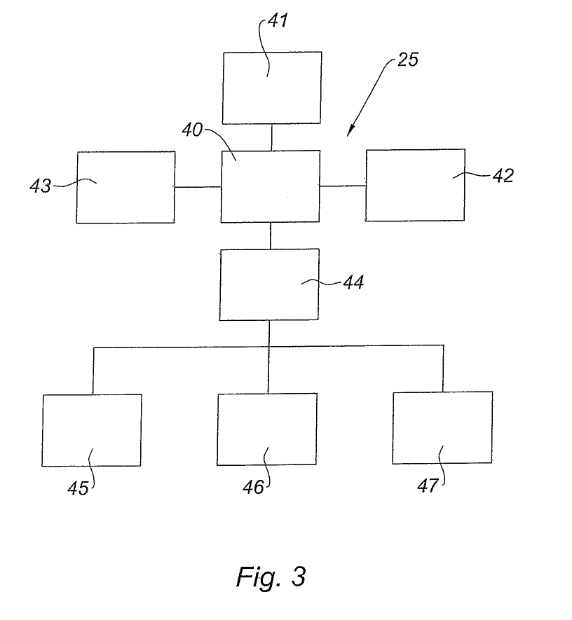

FIG. 3 is a flowchart of the circuits, and, in particular, of the locking circuits, of the operating and control card of the tool of the invention.

In reference to FIG. 1, the device conventionally comprises inside a housing 1, a rear breech 2, a combustion chamber 3, a combustion chamber sleeve 4, a cylinder 5, a piston 6, a head switch (fastener guide) 8 and a fastener support 7. The head switch 8 serves to sense the bearing of weight and closure of the combustion chamber 3.

The combustion chamber sleeve 4 is slidably mounted on the cylinder 5, and closes the combustion chamber 3 at the front and back, together with the piston 6 and the cylinder 5. The piston 6, equipped with a posterior head 6′, is slidably mounted inside the cylinder 5, which is integral within the housing 1. The head switch 8, protruding from the housing 1 at the front, is slidably mounted inside the fastener support 7, which is integral within the housing 1.

At its front, the cylinder 5 contains a recoil buffer 18, integral with the cylinder 5, against which the head 6′ of the piston 6, propelled forward during firing, is intended to abut and, at its rear, a mixing fan 16.

All of these elements of the device have a common axis 9.

Springs 35, 36 are intended to bring the sleeve 4 forward in normal position, when the device no longer bears weight against a support. When the device is in normal position, the sleeve 4 and the head switch 8 are brought forward by the springs 35, 36 and the combustion chamber 3 is open at the rear.

In this case, a nail magazine, not shown, but extending into the front handle 11 of the device, communicates with the head switch 8, for loading nails 10 into the head switch 8.

The device comprises a piezoelectric sensor 23 between the front transverse bottom 22 of the cylinder 5 and the recoil buffer 18, at the front of the latter.

The sensor 23 is electrically connected to a computing module that is arranged on an electronic board 25 which, in this case, is arranged inside the back handle 12 of the device, and substantially comprising operating and control circuits for the device. The sensor 23 is a shock and firing detector.

A gas cartridge 13 as well as the solenoid valve 14 for admitting gas into the chamber 13 are also housed inside the front handle 11 of the device.

Finally, the battery 16 is housed inside a branch 15 forming a bridge between the two handles 11, 12. A spark plug and ignition device, not shown, controlled by a trigger device 17, feeds into the chamber 3.

The operating and control card comprises, in particular, a microcontroller 40, a real-time clock 41, a memory circuit 42, a warning device 43 and locking circuits 44, all of these elements and components being connected to the microcontroller 40.

As already indicated above, the clock 41, in cooperation with the microcontroller 44, makes it possible to date the various events in the service life of the tool, the number of firings, and the failures of the various parts of the tool, that are important to know for those who will be responsible for after-sales service, and for troubleshooting purposes.

The installation of the clock 41, in addition to a quartz crystal in this case, involves the addition of an emergency power supply that can be provided by a back-up battery or a high-capacity capacitor.

In this case, the information is stored in an E2PROM technology memory circuit 42. The memory 42 communicates here again by means of the I2C protocol. The implantation of this memory 42 makes it possible to preserve the harvested information in the absence of a supply voltage and enables the data to be deleted electrically by the microcontroller 40. This formatting can be decided by the microcontroller if the storage space becomes insufficient, by applying the FIFO principal.

The dating of the various firings by the clock 41, in cooperation with the memory circuit 42 and the microcontroller 40, makes it possible to establish a chronology and to determine the interval of time between two firings. This information thus processed by the microcontroller 40 makes it possible to determine if the rate of fire selected by the user is not too high and does not thereby risk damaging the tool in the long run.

The detection of too high a rate of fire, signalled to the user by the warning device 43, controls the locking of the tool by the circuit 44 and can be anticipated in three different ways:
locking ignition 45: with no spark being produced by the spark plug, there is no explosion of the air-gas mixture and therefore no firing;
locking injection 46 of the gas: with the gas not being injected into the combustion chamber 3 by the solenoid valve 14, there is no explosion and therefore no firing;
locking 47 the operation of the injection 8 and ignition 17 control switches: this locking operation makes it possible to block the injection of the gas and the production of the spark plug's spark.

1. Manually controlled and gas-operated tool comprising a cylinder inside of which is slidably mounted a piston for driving a fastening element, under the action of the explosion inside of a combustion chamber of a mixture of gas and air that has been injected therein from a gas cartridge after the tool setting into abutment, followed by actuation of the trigger mechanism for controlling the spark plug, the tool further comprising an element for determining the rate of fire.

2. Tool according to claim 1, in which an element for locking the tool is provided.

3. Tool according to claim 2, in which an element for locking ignition is provided.

4. Tool according to claim 3, in which an element for locking the injection of gas into the chamber is provided.

5. Tool according to claim 4, in which an element for locking injection and ignition control switches is provided.

6. Tool according to claim 1, in which the element for determining the rate of fire includes a real-time clock designed to cooperate with a microcontroller of an operating and control module.

7. Tool according to claim 6, in which a memory is provided for storing the tool's operational data, which cooperates with the microcontroller and the clock in order to control a tool locking element.
